(19) United States
(12) Patent Application Publication
(10) Pub. No.: US 2012/0281180 A1
(43) Pub. Date: Nov. 8, 2012

(54) Rimless eyeglass frame

(76) Inventor: Tony Xin Xiao, Chino, CA (US)

(21) Appl. No.: 13/136,550

(22) Filed: Aug. 3, 2011

Related U.S. Application Data
(60) Provisional application No. 61/518,175, filed on May 2, 2011.

(51) Int. Cl. G02C 1/02; G02C 5/00

(52) U.S. Cl. 351/110; 351/140; 351/141

(57) ABSTRACT

A pair of rimless s eyeglass frame which comprising a pair of lenses, a pair of temple units and a bridge, wherein each lens has at least one slot with a blocking surface that is provided at a predetermined location of the lenses to engage with the press element of the fasten apparatuses that connected to the temple units or the bridge, so as to securely mount the temple units and the bridge onto the lenses to form a pair of rimless eyeglass frame.

### CROSS REFERENCE OF RELATED APPLICATION

This is a non-provisional application that claims the benefit of priority under 35 U.S.C. §119 to a provisional application, application No. 61/518,175, filed May 2, 2011.

### BACKGROUND OF THE PRESENT INVENTION

1. Field of Invention

The present invention relates to an eyeglass frame, and more particularly to a rimless eyeglass frame, wherein the lens has slots with blocking surface that are provided at predetermined locations of the lenses to engage with the press element of the fasten apparatuses that connected to the temples or the bridge, so as to securely mount the temples and the bridge onto the lenses to form a rimless eyeglass frame.

2. Description of Related Arts

A conventional rimless frame is one of very common spectacles being used in the market today. Structurally, the rimless spectacles comprise lenses, temples, and a bridge directly connecting two lenses, wherein more than one connection holes are on each lens, such that the temples and the bridge are connected at the connection holes respectively.

There are two basic mounting mechanisms in current market place. One is so called screw-mounted and other is snap-on. The disadvantage for screw-mounted mechanism is that when the wearer wears the glasses in amount of time, the screw nut may easily loose; and for the snap-on mechanism, the problem came from difficulty of installation. Both mechanisms have same major disadvantage which is difficult to make holes precisely on the lens. Since the lens is generally curved, when drilling the holes on the lens, the drilling device has to be perpendicular to the surface to be drilled to achieve the best drilling effect and accuracy. If the requirement of accuracy on the holes were failed, then the final rimless spectacles will be either crooked or the lens may easily break.

Recently another new innovation is come from U.S. Pat. No. 7,658,492 B2. The inventor has disclosed a cam mechanism and a latch for facilitating assemble of rimless spectacles. The mounting process is simple, easy and in tool-less manner. But unfortunately, the design still has several disadvantages and limitations that never being overcome. For example, this design is only good for mounting negative lens, but it is not workable for positive lens and flat lens. On the other hand, the connector member is clipping outside of the lens so that it cosmetically affects appearance of frame for its fashion need.

The present invention introduces a new method to overcome the problems of the disadvantage and the limitation as mentioned above, which will be no doubt, substantially benefit manufacturers as well as wearers.

### SUMMARY OF THE PRESENT INVENTION

An object of the present invention is to provide a rimless eyeglass frame, wherein the lens has slots with blocking surface that are provided at predetermined locations of the lenses to engage with the press element of the fastening apparatuses that connected to the temples or the bridge when the rimless eyeglass frame has been assembled.

Another object of the present invention is to provide a rimless eyeglass frame, wherein it is not necessary to drill any hole on the lenses. Therefore, the difficulty in Lab jobs is reduced while the optician installing prescription glasses.

Another object of the present invention is to provide a rimless eyeglass frame, wherein the mounting mechanism is entirely concealed inside the lens, so that this innovation does not cosmetically affect appearance of the spectacles, which will benefit manufacturers, frame designers as well as wearers for their fashion need.

Additional advantages and features of the invention will become apparent from the description which follows, and may be realized by means of the instrumentalities and combinations particular point out in the appended claims.

According to the present invention, the foregoing and other objects and advantages are attained by a rimless eyeglass frame, which comprises:

A rimless eyeglass frame, each lens has at least two slots that are provided at predetermined locations from the rear side of the lens and are extended inwardly from the peripheral edges, and the lens further has a blocking surface on the slot; and

a mounting mechanism, which includes fasten apparatuses that are connected to the temple units and the bridge, and the fasten apparatus further has an extension arm, a clipping member and a press element. When the clipping member of the fasten apparatus has been inserted into the slot of the lens, the press element of the fasten apparatus will engage with the blocking surface of the lens to form the rimless spectacles while the rimless eyeglass frame is being assembled.

In accordance with another aspect of the invention, the present invention is a fastening arrangement for mounting a lens and a mounting unit of a rimless eyeglass frame in which the rimless eyeglass frame includes a pair of lenses and a plurality of mounting units which include a pair of temple units and a bridge, wherein the fastening arrangement comprises:

a slot provided on a rear side of the lens and inwardly extended from a peripheral edge;

a recess located at a bottom of the slot; and

a fasten apparatus inserted to and received inside the slot in such a manner that the lens is locked up with the mounting unit while the recess blocks and prevents the fasten apparatus from sliding off from the lens.

In particular, the fasten apparatus comprises an extension arm extended from the mounting unit, and a clipping member connected to the extension arm having a size and a shape complementary to the slot arranged for inserting into the slot in such a manner that the lens is capable of being locked and secured into position through the clipping member.

Preferably, the fasten apparatus further comprises a fastening member for the clipping member which is connected to the clipping member to extend towards the slot from the rear side of the lens such that the fastening member is capable of being tightened to biasing onto the recess at the bottom of the slot, thereby locking and securing the lens into position.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a rimless eyeglass frame showing basic components of the rimless eyeglass frame according to a preferred embodiment of the present invention.

FIG. 2 is a perspective view of the fasten apparatus of the rimless eyeglass frame showing all the components of the fasten apparatus according to the above preferred embodiment of the present invention.

FIG. 3 is a partial perspective view of the lens showing the slot and the recess on the lens according to the above preferred embodiment of the present invention.

FIG. 4 is a front view and a top view of a negative lens showing the slot and the recess on the lens according to the preferred embodiment of the present invention.

FIG. 5 is a sectional view of the structure of the rimless spectacles showing how the fasten apparatus of the bridge and the temple unit mounting the lens in place according to the preferred embodiment of the present invention.

FIG. 6 is a sectional view of the mounting structure between the lens and the fasten apparatus showing how the screw locked up the lens in cross section according to the preferred embodiment of the present invention.

FIG. 7 is a perspective view of the fasten apparatus of the rimless eyeglass frame showing all the components of the fasten apparatus according to the first alteration of the preferred embodiment of the present invention.

FIG. 8 is a partial perspective view of the lens showing the slot and the recess on the lens according to the first alteration of the preferred embodiment of the present invention.

FIG. 9 is a sectional view of the structure of the rimless eyeglass frame showing how the fasten apparatus of the bridge and the temple unit mounting the lens in place according to the first alteration of the preferred embodiment of the present invention.

FIG. 10 is a perspective view of the fasten apparatus of the rimless eyeglass frame showing the fasten apparatus having two extension arms according to the second alteration of the preferred embodiment of the present invention.

FIG. 11 is a sectional view of the structure of the rimless eyeglass frame that the fasten apparatus having two extension arms and showing how the fasten apparatus of the bridge and the temple unit mounting the lens in place according to the second alteration of the preferred embodiment of the present invention.

FIG. 12 is a sectional view of the mounting structure between the lens and the fasten apparatus showing how the screw locked up the lens in cross section according to the second alteration of the preferred embodiment of the present invention.

FIG. 13A is a perspective view of the fasten apparatus of the rimless eyeglass frame showing all the components of the fasten apparatus according to the third alteration of the preferred embodiment of the present invention.

FIG. 13B is a perspective view of the fasten apparatus of the rimless eyeglass frame showing all the components of the fasten apparatus according to the fourth alteration of the preferred embodiment of the present invention.

FIG. 13C is a perspective view of the fasten apparatus of the rimless eyeglass frame showing all the components of the fasten apparatus according to the fifth alteration of the preferred embodiment of the present invention.

FIG. 13D is a sectional view of the mounting structure of the rimless eyeglass frame that showing how an inserter being placed between the lens and the clipping member for mounting the lens according to the fifth alteration of the preferred embodiment of the present invention.

FIGS. 14, 15 and 16 are the sectional views of a flat lens, a positive lens and a negative lens showing variation of the blocking surface according to the preferred embodiment of the present invention.

### DETAILED DESCRIPTION OF THE PREFERRED EMBODIMENT

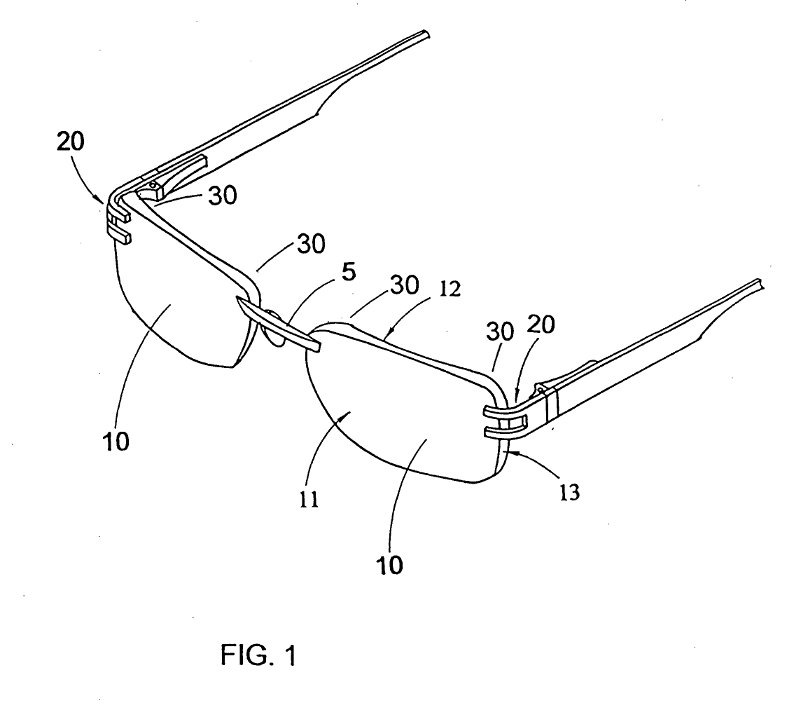

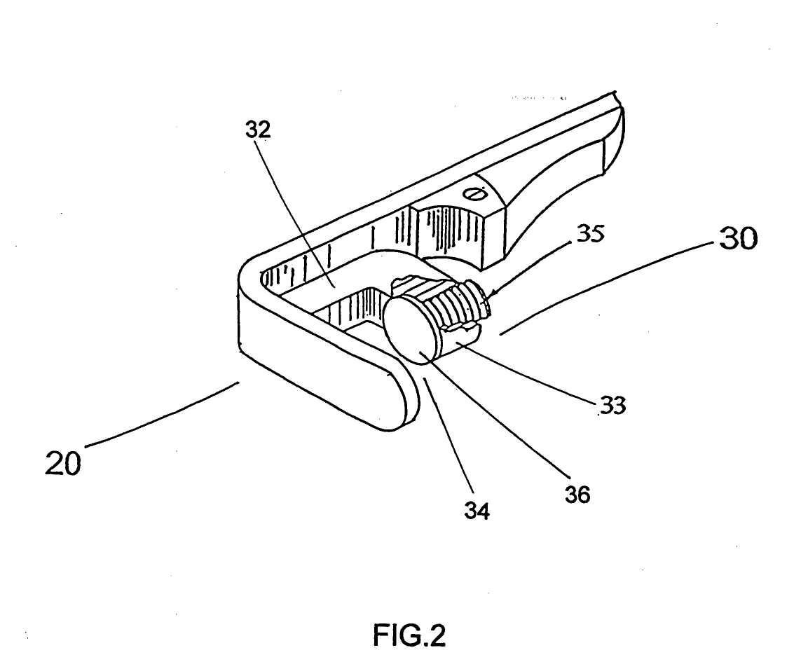

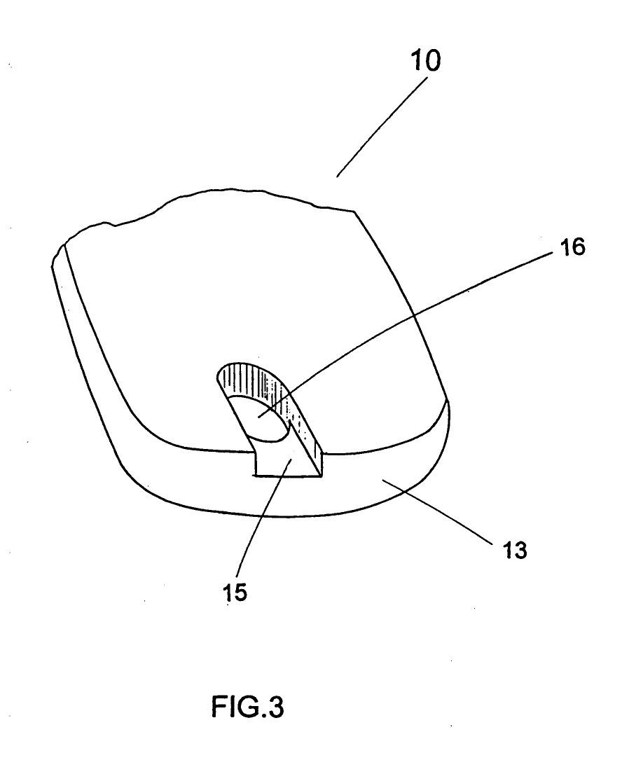

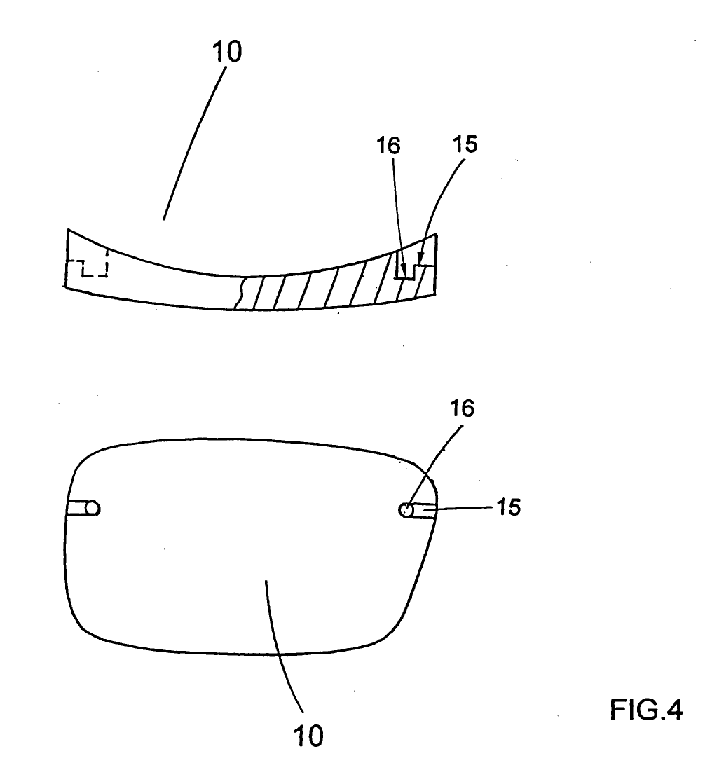

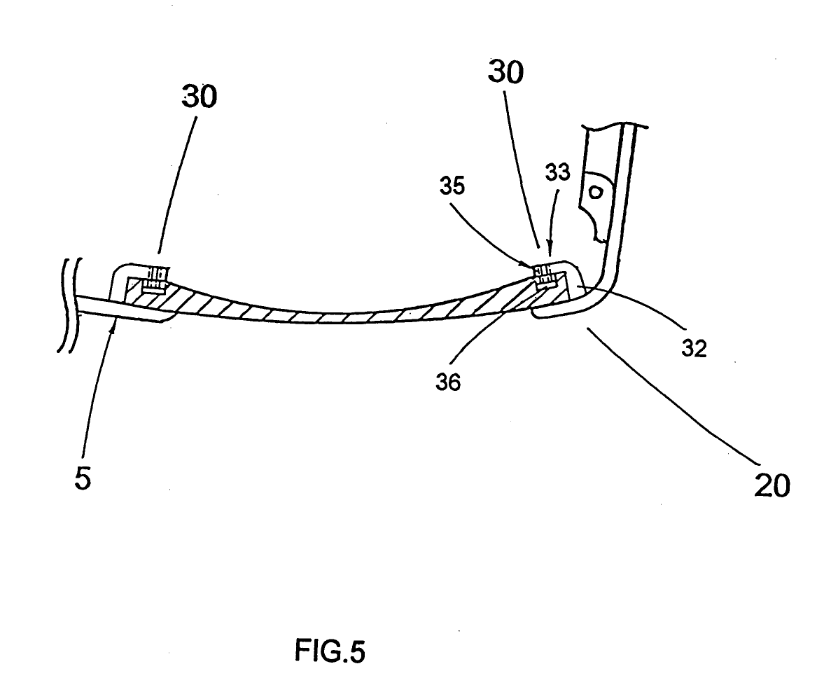

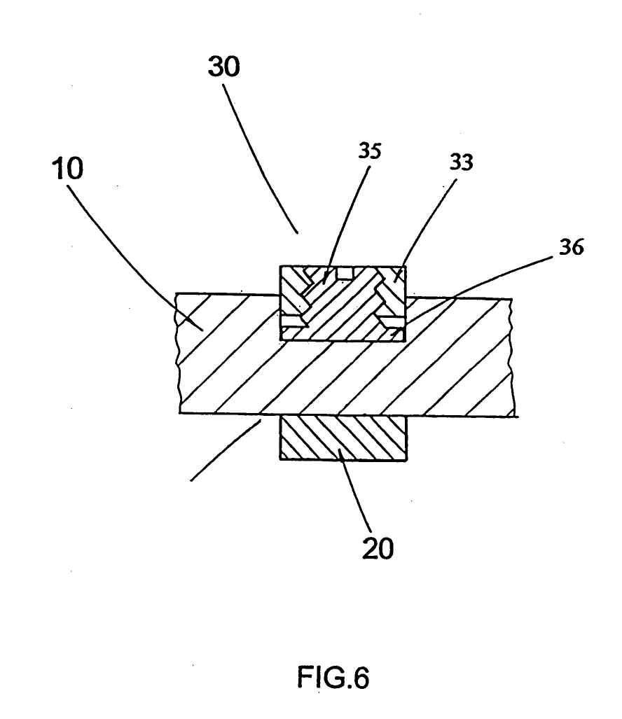

Referring to FIG. 1 to FIG. 6 of the drawings, a pair of rimless eyeglass frame according to the preferred embodiment of the present invention is illustrated. The rimless eyeglass frame comprises a bridge 5, two temple units 20, two lenses 10 and fasten apparatuses 30 that connected to the temple unit 20 and the bridge 5 for mounting the lenses 10 in position. Each of the lenses 10 has a front side 11, a rear side 12, and a peripheral edge 13 as shown in FIG. 3 The lens 10 has at least one slot 15, which is provided at a predetermined location and is extended inwardly from the peripheral edge 13, and a recess 16 is formed on the bottom of the slot 15. The temple unit 20 has at least one fasten apparatus 30 and the bridge 5 has two fasten apparatuses 30. The fasten apparatus 30 includes a clipping member 33 and an extension arm 32, which is extended from the temple units 20 or the bridge 5 to connect with the clipping member 33. Further more, the clipping member 33 has a press element 34 that includes a screw 35 and a screw head 36 for engaging with the recess 16 of the lens 10. On the other hand, the thickness of the lens portion that remains in the slot 15 of the lens 10 is slightly smaller than the gap between the temple unit 20 and the clipping member 33, while the width of the clipping member 33 is slightly smaller than the width of the slot 15. In addition, the screw head 36 has a corresponding size and shape to the recess 16 of the slot 15. Therefore, when the rimless eyeglass frame is being assembled, the lens 10 can be able to insert into the fasten apparatus 30 freely, the clipping member 33 can be perfectly fitted onto the slot 15, and the screw head 36 can be able to press the recess 16 by screwed in the screw 35 for locking up the lens 10 to form a pair of rimless eyeglass frame.

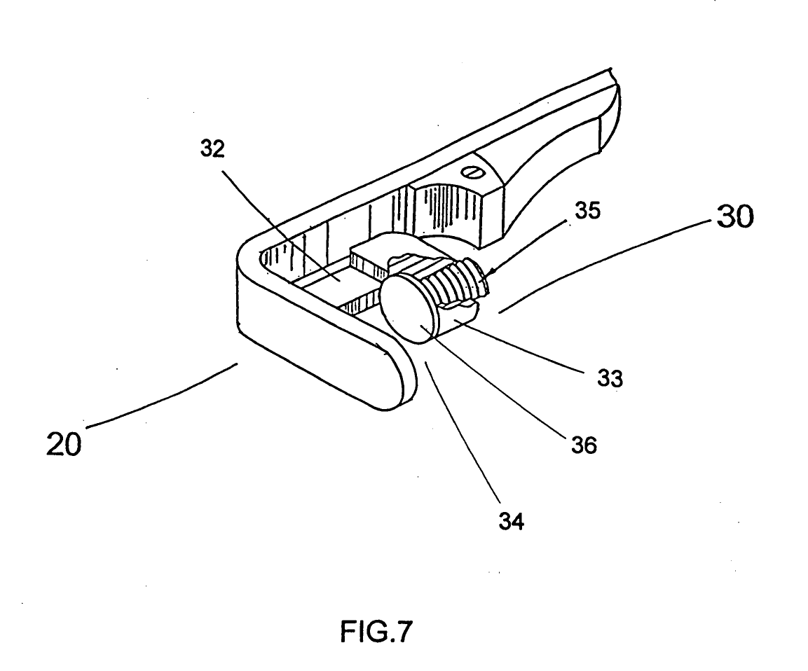

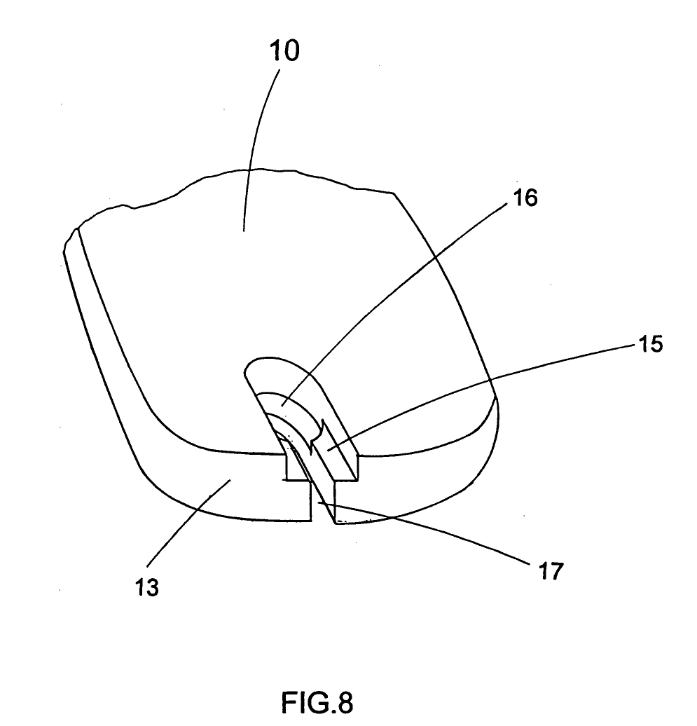

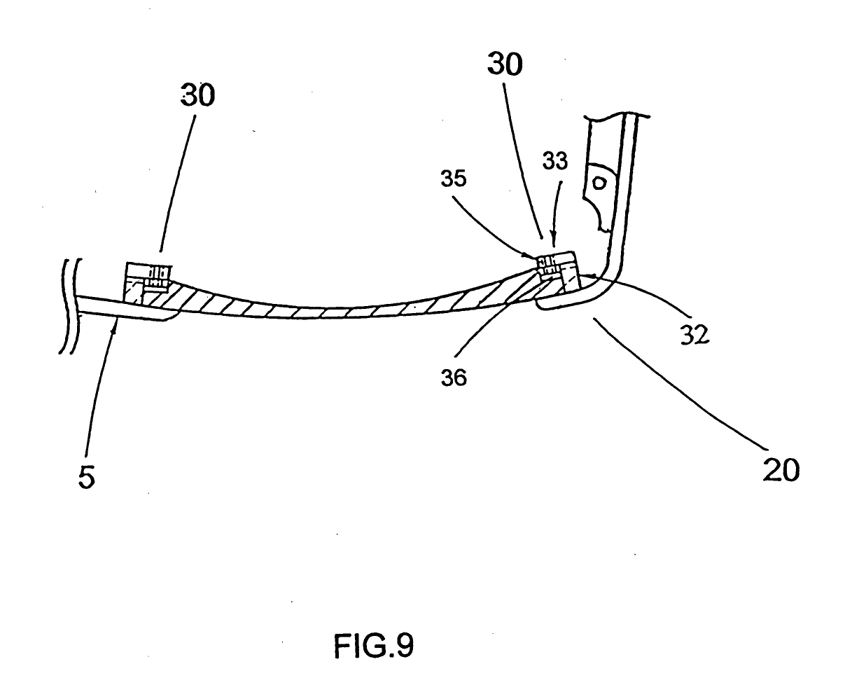

Referring to FIG. 7 to FIG. 9 of the drawings, the first alteration has been made from the preferred embodiment of the present invention. The lens 10 further has a second step slot 17 which cuts through the lens 10 from the slot 15, and the extension arm 32 of the fasten apparatus 30 has a corresponding size and shape to fit into the second step slot 17, so that the extension arm 17 can be concealed inside the lens 10 when the rimless eyeglass frame has been assembled. The advantage of this design is, the extension arm is more closer to the press element, so as to ensure the fasten apparatus does not cosmetically affect appearance of the spectacles, which will benefit manufacturers, frame designers as well as wearers for their fashion need.

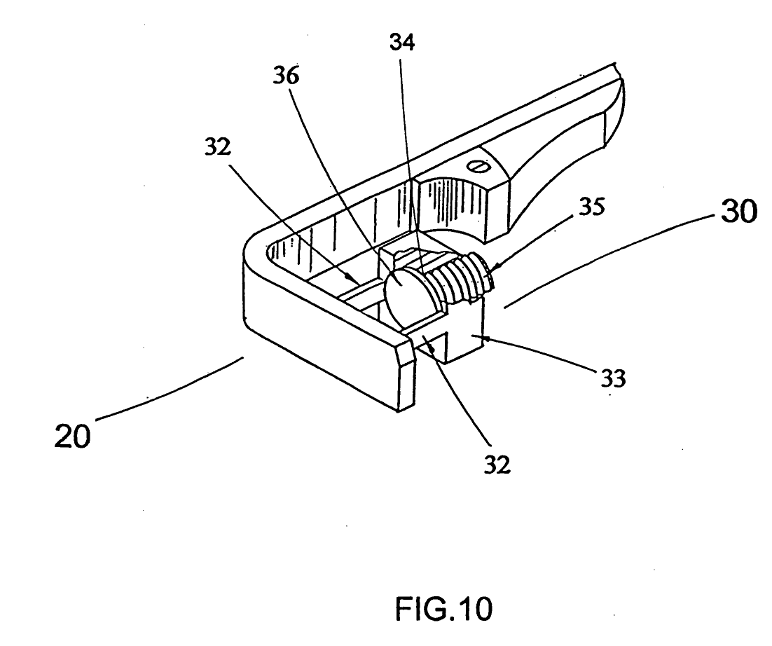

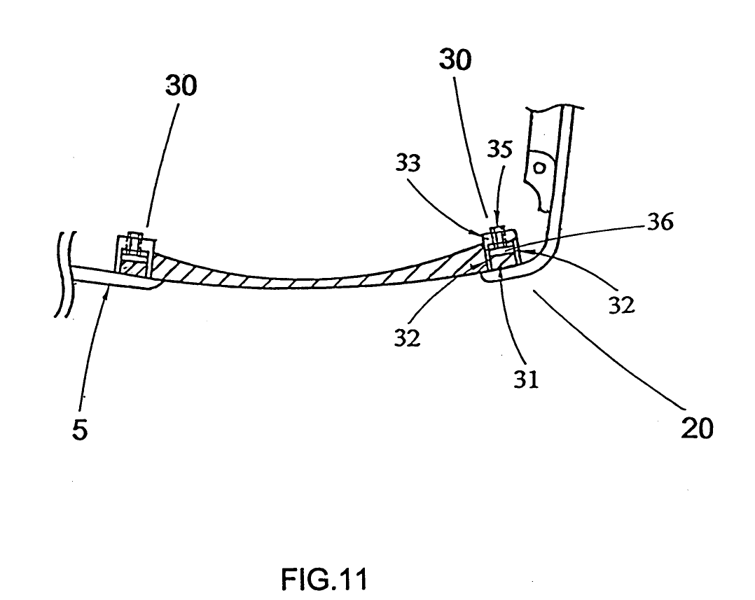

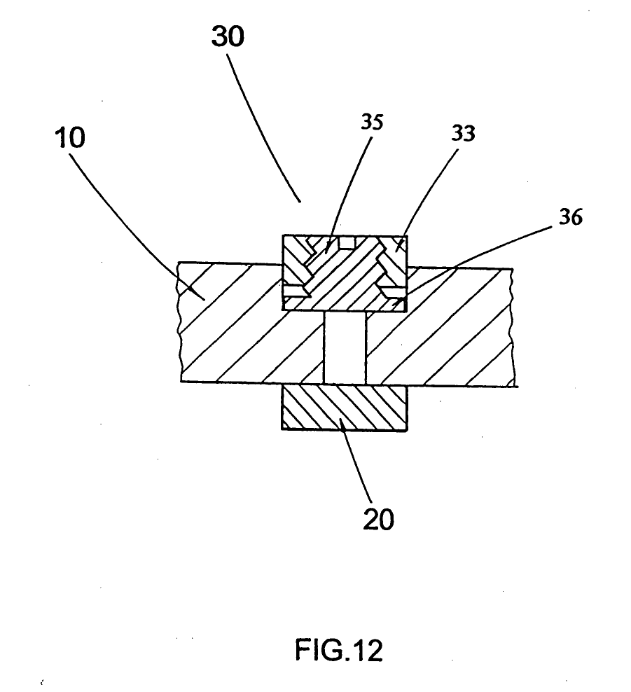

As shown in FIG. 10 to FIG. 12, this is the second alteration of the design, which the fasten apparatus has two extension arms 32 and one clipping member 33. It is good to mention that extension arms 32 are slightly smaller than the second step slot 17, so that the extension arms 32 can be concealed inside the lens 10 when the rimless eyeglass frame has been assembled. The reason for this design is because two extension arms 32 that connected to the temple unit 20 or the bridge 5 and the clipping member 33 have built a frame structure for holding the lens 10 in position through the slot 15 and the second step slot 17. Practically, it makes the structure of the frame much stronger than all the previous designs.

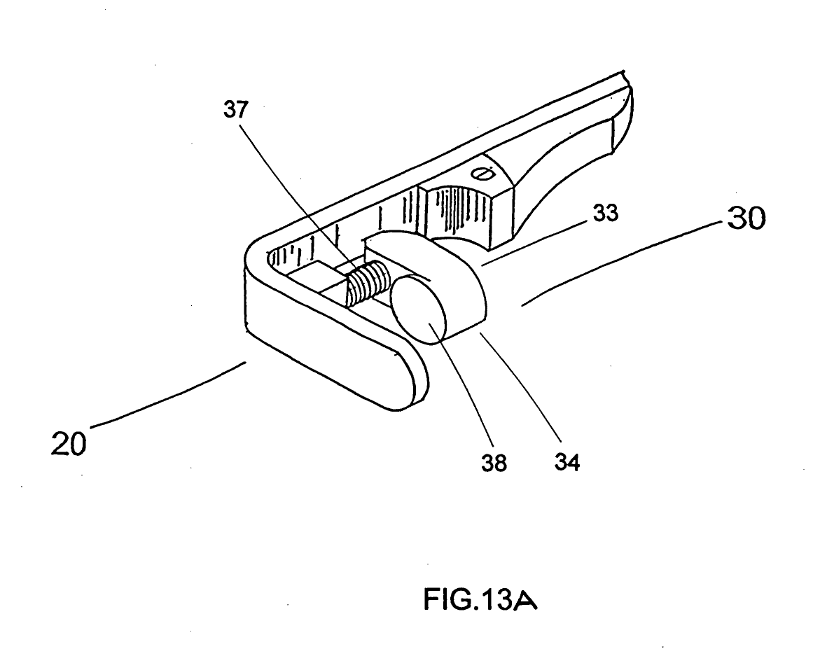

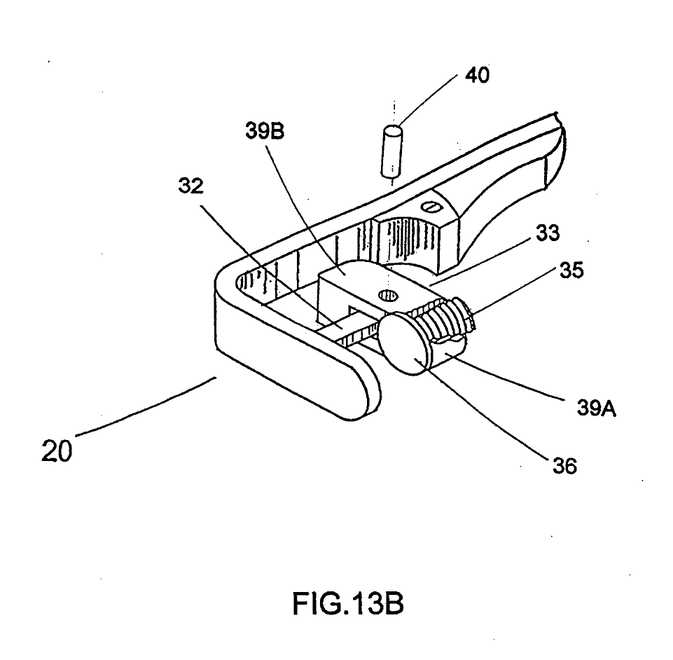

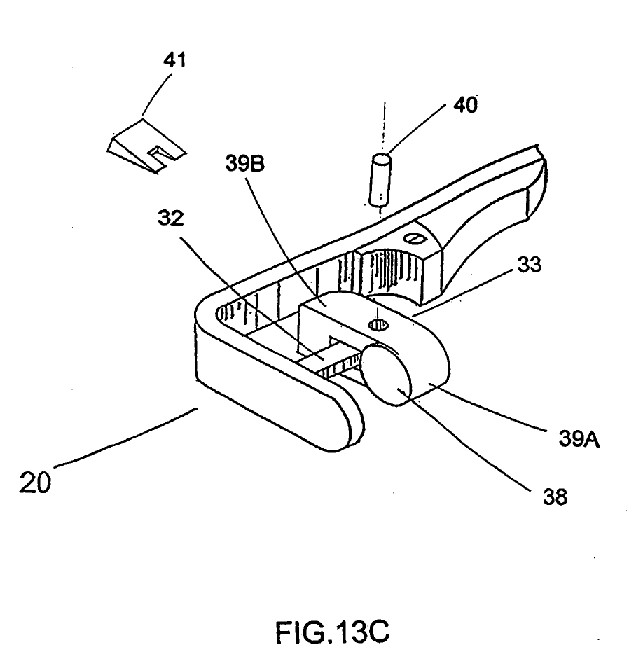

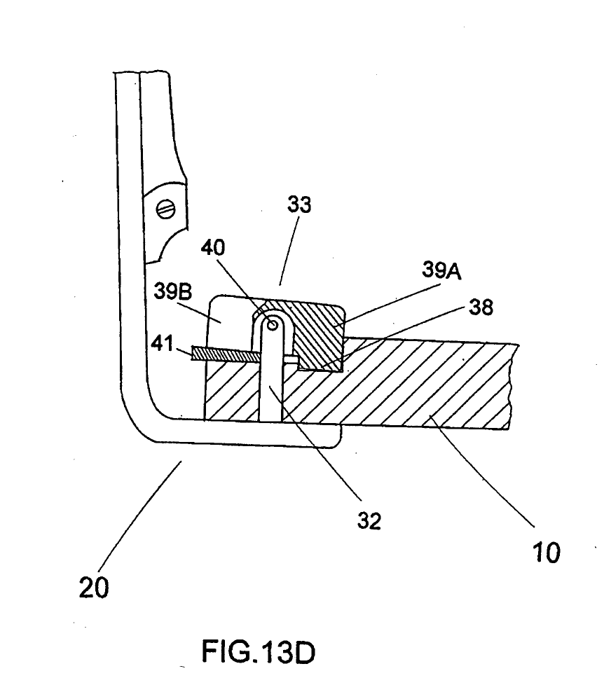

As shown in FIG. 13A, this is the third alteration of the design. The extension arm 32 of the fasten apparatus 30 has an adjustable element 37 which the length of extension arm 32 can be adjustable. For example, the adjustable element 37 can be an adjustable screw or a post with different lengths that attach to the temple units 20 or the bridge 5. On the other hand, the press element 34 of the clipping member 33 has a protrusion 38 for engaging with the recess 15 of the lens 10, so that when making a pair of rimless eyeglass frame, the thickness of the lens 10 in the slot 15 can be variable, and the lens 10 can be locked up by adjustable element 37 while the protrusion 38 of the clipping member 33 blocks and prevents the fasten apparatus 30 sliding off from the lens 10.

clipping member 33 in the middle by inserting an axle 40 to form a seesaw device, which inner end of the clipping member 39A goes up, outer end of the clipping member 39B goes down. The clipping member 33 has a press element 34 which is located in the inner end of the clipping member 39A. The press element 34 includes a screw 35 and a crew head 36, when a lens 10 has been inserted into the fasten apparatus 30, by rotating the screw 35, the screw head 36 is able to press the lens 10, so that the inner end of the clipping member 39A goes up, while the outer end of the clipping member 39B goes down to push the lens 10. In this circumstance, both ends 39A and 39B push the lens 10 for finding its balance, therefore, the lens 10 can be securely lock up by the press element 34 when the rimless frame has been assembled.

As shown in FIG. 13C and FIG. 13D, this is the fifth alteration of the design. This design is similar to the fourth alteration of the design, the major different is, instead of using a screw for locking up the lens 10, we use a protrusion 38 to replace the screw head and add an inserter 41. When the inserter 41 is inserted between the outer end of the clipping member 39B and the lens 10, the outer end of the clipping member 39B goes up, while the inner end of the clipping member 39A goes down to press the lens 10, therefore, the lens 10 can be securely lock up by the inserter 41 when the rimless frame has been assembled. In Actual practice, the clipping member 33 and the inserter 41 can be made of nylon, plastic, acetate materials and etc., it makes the appearance of the frame beautiful because there is no hole and no screw on the frame, ultimately will benefit manufacturers, frame designers as well as wearers for their fashion need.

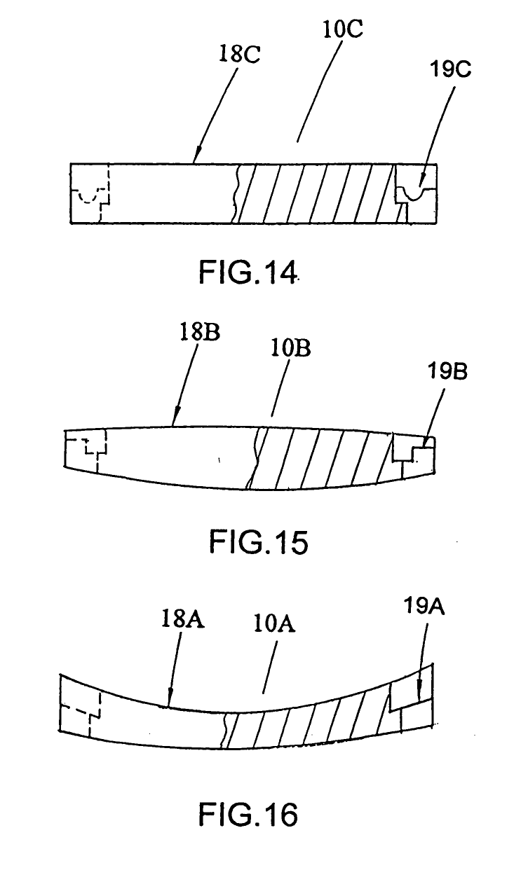

The drawings of FIG. 14 to FIG. 16, showing different kinds of lenses and variety of blocking surfaces on the slot 15. Basically, there are three kinds of lenses: A negative lens 10A, a positive lens 10B and a flat lens 10C. The negative lens 10A has a concave surface 18A on the rear side of the lens; the positive lens 10B has a convex surface 18B on the rear side of the lens; and the flat lens 10C has a flat surface 18C on both sides of the lens. In order to lock up the clipping member 33, the blocking surface 19 is needed because when the fasten apparatus 30 has been inserted into the lens 10, the blocking surface 19 will block and prevent the fasten apparatus 30 sliding off from the open edge of the slot 15. In addition, the blocking surface 19 can be an inclined plane 19A, a cylinder recess 19B and a cavity 19C as shown in FIG. 14 to FIG. 16. All these blocking surfaces will be functioned the same for blocking and preventing the fasten apparatus 30 moving out from the lens 10.

It is worth to mention that for the conventional drill-mount eyeglass frame, there are two drill points that mount onto the temples, and if one point breaks, the other will follow. But for this new design, the whole slot is the holding point for the lens, and in order to break, it has to break the whole slot, which makes the new eyeglass frame much stronger. In another aspect, cutting lens for this new design is also simple and fast, the optician only need to level the lens before cutting, there is no need to make angles, to drill any holes on the lenses. Therefore, the difficulty in Lab jobs has been reduced, which will benefit doctors, opticians and manufacturer as well.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A fastening arrangement for mounting a lens and a mounting unit of a rimless eyeglass frame in which the rimless eyeglass frame includes a pair of lenses and a plurality of mounting units which include a pair of temple units and a bridge, wherein said fastening arrangement comprises:
a slot provided on a rear side of the lens and inwardly extended from a peripheral edge;
a recess located at a bottom of said slot; and
a fasten apparatus inserted to and received inside said slot in such a manner that the lens is locked up with the mounting unit while said recess blocks and prevents said fasten apparatus from sliding off from the lens.

2. The fastening arrangement, as recited in claim 1, wherein said fasten apparatus comprises an extension arm extended from the mounting unit, and a clipping member connected to said extension arm having a size and a shape complementary to said slot arranged for inserting into said slot in such a manner that the lens is capable of being locked and secured into position through said clipping member.

3. The fastening arrangement, as recited in claim 2, wherein said fasten apparatus further comprises a fastening member for said clipping member which is connected to said clipping member to extend towards said slot from the rear side of the lens such that said fastening member is capable of being tightened to biasing onto said recess at said bottom of said slot, thereby locking and securing the lens into position.

4. The fastening arrangement, as recited in claim 3, wherein a distance between said clipping member and the mounting unit is slightly larger than a thickness of the lens measured from said bottom of said slot and a front side of the lens such that the lens is capable of positioning and inserting between said clipping member and the mounting unit and then securing into position through tightening said fastening member, thereby greatly facilitating an assembly process of the spectacle frame.

5. The fastening arrangement, as recited in claim 3, further comprising a second step slot cutting through the lens from said slot which is sized to fit said extension arm in such a manner that said extension arm is concealed inside the lens through said second step slot.

6. The fastening arrangement, as recited in claim 5, wherein said extension arm has an adjustable element such that a length of said extension arm is adjustable, wherein said clipping member has a protrusion which is sized to fit said recess of the lens, thereby different lens of different thickness can be fitted into said fastening apparatus through said adjustable element which is then secured and locked into position through said recess, and said clipping member is blocked and prevented from sliding off through said protrusion of said clipping member.

7. The fastening arrangement, as recited in claim 6, wherein said fastening member is a screw, wherein said extension arm is extended from the mounting unit and connected to said clipping member at a middle position by an axle to form a seesaw structure such that when said screw is rotated to tightening the lens, two ends of said clipping members push the lens to locate a balancing position for the lens such that the lens is secured and locked into position.

8. The fastening arrangement, as recited in claim 6, wherein said fastening member is an inserter, wherein said extension arm is extended from the mounting unit and connected to said clipping member at a middle position by an axle to form a seesaw structure such that when inserting said inserter between said clipping member and the lens, two ends of said clipping members push the lens to locate a balancing position for the lens such that the lens is secured and locked into position.

9. The fastening arrangement, as recited in claim 6, wherein said extension arm has two bars positioned at two sides of said clipping member respectively and said fastening member is positioned in a middle of said clipping member, thereby a strength of a structure of said fasten apparatus is reinforced.

10. A pair of rimless eyeglass frame, comprising:
a pair of lenses, wherein each of said lenses has a front side, a rear side, and a peripheral edge; wherein each of said lenses has at least two slots which are provided at predetermined locations, wherein each said slot is provided from said rear side of said lens and is extended inwardly from said peripheral edge respectively, each said lens further has a recess located at a bottom of said slot; and
a mounting mechanism which comprises a pair of temple units, a bridge, and a plurality of fasten apparatuses, wherein each of said temple units has at least one said fasten apparatus and said bridge has two fasten apparatuses located at two sides of said bridge respectively;
wherein each of said lenses can be locked up when said slots have been inserted respectively inside of said fasten apparatus of each of said temple units and said bridge to form said pair of rimless eyeglass frame while said recess blocks and prevents said fasten apparatus sliding off from said lens.

11. The rimless eyeglass frame, as recited in claim 10, wherein said fasten apparatus of said mounting mechanism comprises: an extension arm and a clipping member, wherein said extension arm is extended from each of said temple unit or said bridge and connected with said clipping member which has a corresponding size and a shape to said slot, wherein said clipping member further has a screw, when said clipping member of said fasten apparatus has been inserted into said slot, said screw can be tighten up into said recess of said slot, so that said lens can be securely locked up by said screw.

12. The rimless eyeglass frame, as recited in claim 11, wherein in said fasten apparatus of said mounting mechanism, the distance between said clipping member and said temple unit or said bridge is slightly larger than the thickness of said lens between the bottom of said slot and said front side of said lens, so that said fasten apparatus can be freely inserted into said lenses when said rimless eyeglass frame has been assembled.

13. The rimless eyeglass frame, as recited in claim 10, wherein each of said lenses further has a second step slot which cuts through said lens from said slot, and said extension arm of said fasten apparatus has a corresponding size and shape to fit into said second step slot, so that said extension arm can be concealed inside said lens when said rimless eyeglass frame has been assembled.

14. The rimless eyeglass frame, as recited in claim 13, wherein in said fasten apparatus of said mounting mechanism, said extension arm has two bars which located at two sides of said clipping member respectively, and said screw is in the middle, so that said fasten apparatus has much strong structure.

15. The rimless eyeglass frame, as recited in claim 11, wherein in said fasten apparatus of said mounting mechanism, said extension arm has an adjustable element which the length of said extension arm can be adjustable, and said clipping member includes a protrusion which corresponds to said recess of said lens, so that when making a pair of rimless eyeglass frame, the thickness of said lens between the bottom of said slot and said front side of said lens can be variable, and said lens can be locked up by adjustable element while said protrusion of said clipping member blocks and prevents said fasten apparatus sliding off.

16. The rimless eyeglass frame, as recited in claim 13, wherein in said fasten apparatus of said mounting mechanism, said extension arm is extended from each of said temple unit or said bridge and connected to said clipping member in the middle by an axle to form a seesaw device, wherein by rotating said screw of said clipping member, both ends of said clipping member push said lens for finding its balance, so as to securely lock up said lens when said rimless eyeglass frame has been assembled.

17. The rimless eyeglass frame, as recited in claim 13, wherein in said fasten apparatus of said mounting mechanism, said extension arm is extended from each of said temple unit or said bridge and connected to said clipping member in the middle by an axle to form a seesaw device, wherein by inserting an inserter between said clipping member and said lens, both ends of said clipping member push said lens for finding its balance, so as to securely lock up said lens when said rimless eyeglass frame has been assembled.

18. A pair of rimless eyeglass frame, comprising:
a pair of lenses, wherein each of said lenses has a front side, a rear side, and a peripheral edge; wherein each of said lenses has at least two slots which are provided at predetermined locations from said rear side of said lens and extended inwardly from said peripheral edges respectively; wherein the thickness of said lens at said peripheral edge of said slot is larger than the thickness of said lens at the inner portion of said slot, so as to form a blocking surface for a fasten apparatus; and
a mounting mechanism, which includes a pair of temple units and a bridge, wherein each of said temple units has at least one fasten apparatus and said bridge has two fasten apparatuses that located at two sides of said bridge respectively, wherein said fasten apparatus has at least one extension arm which is extended from said temple unit or said bridge and connected with a clipping member, which has a corresponding size and shape to said slot, wherein said clipping member further has a press element for pushing and locking said lens while said blocking element blocks and prevents said fasten apparatus sliding off from said lens when said rimless eyeglass frame has been assembled.

19. The rimless eyeglass frame, as recited in claim 18, wherein said blocking surface for engaging with said press element can be a cylinder recess, a cavity or an inclined plane; and while said press element can be a screw, a pin or a inserter for locking up said lens when said rimless eyeglass frame has been assembled.

20. The rimless eyeglass frame, as recited in claim 19, wherein each of said lenses further has a second step slot which cuts through said lens from said slot, and said extension arm of said fasten apparatus has a corresponding size and shape to fit into said second step slot, so that said extension arm can be concealed inside said lens when said rimless eyeglass frame has been assembled.
